(19) United States
(12) Patent Application Publication
(10) Pub. No.: US 2016/0320541 A1
(43) Pub. Date: Nov. 3, 2016

(54) BACKLIGHT MODULE AND DISPLAY DEVICE

(71) Applicant: BOE TECHNOLOGY GROUP CO., LTD., Beijing (CN)

(72) Inventor: Kiman KIM, Beijing (CN)

(73) Assignee: BOE TECHNOLOGY GROUP CO., LTD., Beijing (CN)

(21) Appl. No.: 15/141,378

(22) Filed: Apr. 28, 2016

(30) Foreign Application Priority Data
Apr. 28, 2015 (CN) 201510207963.3

(51) Int. Cl. F21V 8/00

(52) U.S. Cl. CPC G02B 6/005; G02B 6/0066; G02B 6/0065; G02B 6/0055

(57) ABSTRACT

The present disclosure provides a backlight module and a display device. The backlight module includes: a light guide plate; a monochromatic light source arranged at a light-entering side of the light guide plate; an optical grating arranged at a side of a light-exiting surface of the light guide plate, wherein monochromatic light from the monochromatic light source is diffracted by the optical gating and directed in a direction perpendicular to the light guide plate; and a quantum dot plate arranged at the side of the light-exiting surface of the light guide plate and configured to convert the diffracted monochromatic light into white light.

### CROSS-REFERENCE TO RELATED APPLICATION

The present application claims a priority of the Chinese patent application No. 201510207963.3 filed on Apr. 28, 2015, which is incorporated herein by reference in its entirety.

### TECHNICAL FIELD

The present disclosure relates to the field of liquid crystal display technology, in particular to a backlight module and a display device.

### BACKGROUND

Liquid crystal display (LCD), as a mainstream display device, has been widely used nowadays. For the LCD used by a mobile terminal, manufacturers always try to increase its optical efficiency so as to reduce the power consumption, and try to reduce its thickness so as to improve the mobility.

In order to increase the optical efficiency, an optical grating may be arranged at a light-existing surface of a light guide plate. In this way, it is able to remarkably increase a light intensity in a vertical direction even without any additional converging sheet. In addition, the resultant structure is simple, so it is able to simplify the assembly and manufacture of the LCD.

However, in the related art, diffraction may occur when the light with different wavelengths pass through slits of the optical grating, and depending on their wavelengths, the diffracted light may be directed in different directions relative to the grating. Hence, chromatic aberration may occur due to different viewing angles of a viewer, which limits the application of the light guide plate.

### SUMMARY

An object of the present disclosure is to provide a backlight module and a display device, so as to direct light, from a light source and refracted by a grating, in a direction perpendicular to a light guide plate, thereby to prevent the occurrence of chromatic aberration due to different viewing angles of a viewer.

In one aspect, the present disclosure provides in some embodiments a backlight module, including: a light guide plate; a monochromatic light source arranged at a light-entering side of the light guide plate; an optical grating arranged at a side of a light-exiting surface of the light guide plate, wherein monochromatic light from the monochromatic light source is diffracted by the optical gating and directed in a direction perpendicular to the light guide plate; and a quantum dot plate arranged at the side of the light-exiting surface of the light guide plate and configured to convert the diffracted monochromatic light into white light.

Alternatively, the monochromatic light source is a blue light source, and light from the blue light source has a wavelength not greater than 460 nm.

Alternatively, the grating has a period of 300 nm to 390 nm.

Alternatively, the light guide plate is a polymethyl methacrylate (PMMA) or Acryl light guide plate.

Alternatively, the backlight module further includes a reflector arranged at a side of the light guide plate away from the quantum dot plate.

Alternatively, the monochromatic light source is arranged at a side of the light guide plate away from the quantum dot plate.

Alternatively, the optical grating is arranged between the light guide plate and the quantum dot plate.

Alternatively, the monochromatic light source is arranged between the reflector and the light guide plate.

Alternatively, the monochromatic light source is arranged at a region formed by an extension of a light transmission region between a surface of the light guide plate adjacent to the quantum dot plate and the reflector in a direction parallel to the light guide plate.

In another aspect, the present disclosure provides in some embodiments a display device including the above-mentioned backlight source.

According to the embodiments of the present disclosure, the light from the monochromatic light source of the backlight module are diffracted by the optical grating and then directed in a direction perpendicular to the light guide plate. Then, the monochromatic light from the monochromatic light source are converted by the quantum dot plate into white light. As a result, it is able to direct the light with different wavelengths in a direction perpendicular to the light guide plate, thereby to prevent the occurrence of the chromatic aberration due to different viewing angles of the viewer.

### BRIEF DESCRIPTION OF THE DRAWINGS

FIG. 1 is a schematic view showing a backlight module in the related art;

FIG. 2 is a schematic view showing a backlight module according to one embodiment of the present disclosure;

FIG. 3 is another schematic view showing the backlight module according to one embodiment of the present disclosure; and

FIG. 4 is yet another schematic view showing the backlight module according to one embodiment of the present disclosure.

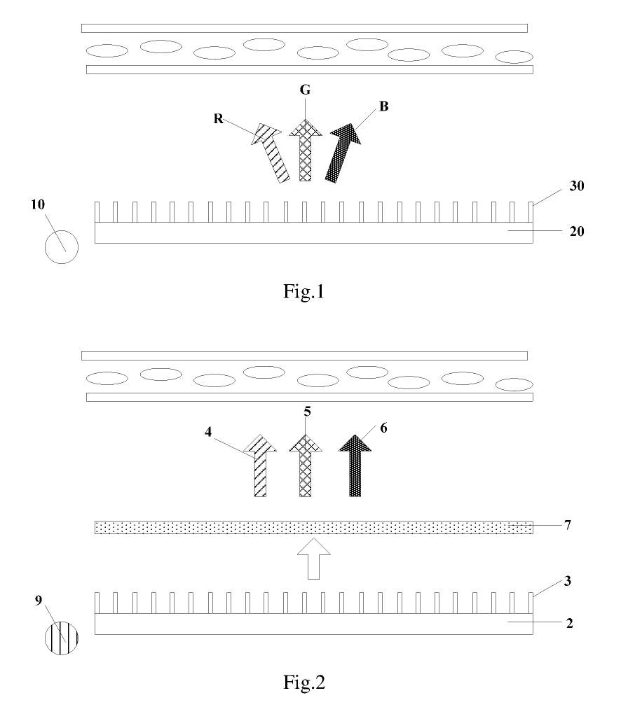

### REFERENCE SIGN LIST

10 white light source

20 light guide plate

30 grating

R red light beam

G green light beam

B blue light beam

2 light guide plate

3 grating

4 red light beam

5 green light beam

6 blue light beam

7 quantum dot plate

8 reflector

9 monochromatic light source

11 light transmission region

### DETAILED DESCRIPTION OF THE EMBODIMENTS

In order to make the objects, the technical solutions and the advantages of the present disclosure more apparent, the present disclosure will be described hereinafter in conjunction with the drawings and embodiments.

As shown in Fig., a backlight module in the related art includes a white light source 10 and a light guide plate (LGP) 20 with an optical grating 30. White light entering the optical grating 30 are converged, so it is unnecessary to provide a prism plate. However, the white light from the light source 10 have different wavelengths, and diffraction may occur after the light passes through slits of the grating. Depending on the wavelengths, the diffracted red (R), green (G) and blue (B) light may be directed in different directions relative to the grating 30. Hence, chromatic aberration may occur due to different viewing angles of a viewer, which limits the application of the light guide plate.

The present disclosure provides in some embodiments a backlight module which, as shown in FIG. 2, includes a light guide plate 2, a monochromatic light source 9 arranged at a light-entering side of the light guide plate 2, an optical grating 3 arranged at a side of a light-exiting surface of the light guide plate 2, wherein monochromatic light from the monochromatic light source 9 is diffracted by the optical gating and directed in a direction perpendicular to the light guide plate 2; and a quantum dot plate 7 arranged at the side of the light-exiting surface of the light guide plate 2 and configured to convert the diffracted monochromatic light into white light.

In some embodiments of the present disclosure, the monochromatic light from the monochromatic light source 9 passes through slits of the grating 3 and then be directed in a direction substantially perpendicular to the light guide plate 2, theoretically at an angle of −15° to +15° relative to a direction perpendicular to the light guide plate 2. Alternatively, the monochromatic light source is a blue light source, and light from the blue light source has a wavelength not greater than 460 nm. Furthermore, the light from the monochromatic light source is transmitted to the quantum dot plate 7, and quantum dots of the quantum dot plate 7 are excited by the blue light so as to emit the other monochromatic light, which are mixed with the blue light to form the white light. As a result, it is able to direct the light with different wavelengths in a direction perpendicular to the light guide plate, thereby to prevent the occurrence the chromatic aberration due to different viewing angles of the viewer.

In order to ensure that the monochromatic light through the slits of the grating 3 is directed in a direction perpendicular to the light guide plate 2, the grating may have a period of 300 to 390 nm. Otherwise, the light may be directed obliquely relative to the light guide plate 2, rather than in a direction perpendicular to the light guide plate 2, and as a result, the convergence of the light beams may be adversely affected.

The light guide plate is a PMMA or Acryl light guide plate. Usually, the PMMA light guide plate is adopted by an LCD, and the Acryl light guide plate is adopted by a mobile terminal, such as a mobile phone.

The backlight module in the embodiments of the present disclosure will be illustratively described hereinafter.

The backlight module includes a blue light source capable of emitting light with a wavelength of 450 nm, and a PMMA light guide (with a refractive index of 1.49). In the case that the blue light is transmitted to the light guide plate at an angle of 65° and the optical grating has a period (Λ) of 330 nm, the light passing through the slits of the grating may be calculated by the following diffraction equation 1: sin φₘ−nₛ sin θᵢₙ=λ·m/Λ, where Λ represents the period of the grating, λ represents a wavelength of the blue light beam, m represents the times of diffraction, θₘ represents an incident angle, nₛ represents a refractive index of the light guide plate and φₘ represents an emergent angle. According to the diffraction equation 1, most of the light passing through the slits of the grating consists of the light directly passing through the slits and the light reflected by the optical grating once. In addition, most of the light has angles of −15° to +15° relative to a direction perpendicular to the light guide plate, i.e., 0°.

Of course, in some embodiments of the present disclosure, the diffraction efficiency of the optical grating depends on its width (W), height (h) and shape, and the diffraction efficiency may increase along with an increase in a distance between the optical grating and the light source. Hence, it is able to provide the backlight module with uniform luminance by appropriating setting the distance between the optical grating and the light source.

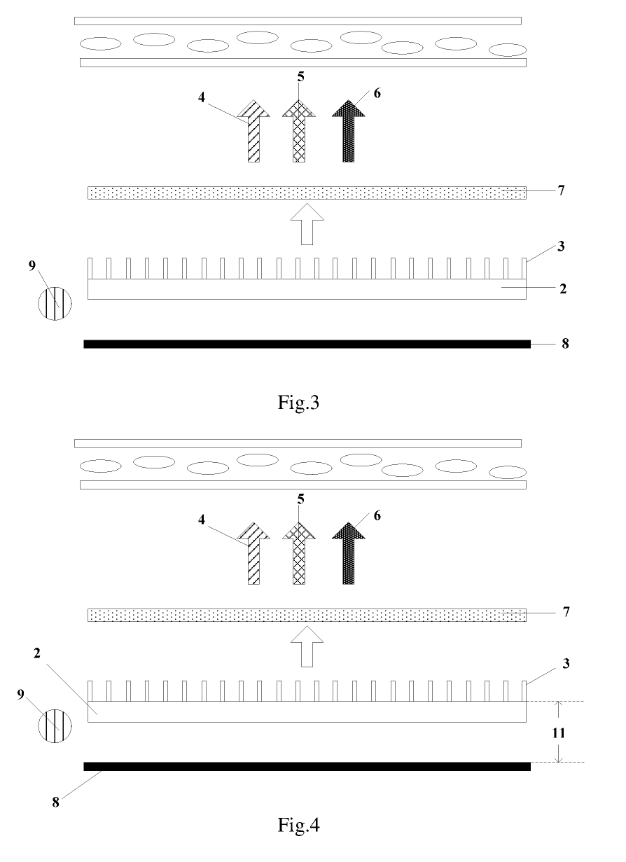

As shown in FIG. 3, in order to increase the luminance, a reflector 8 may be arranged at a side of the light guide plate 2 away from the quantum dot plate 7. To be specific, the non-scattered light from the monochromatic light source 9 may be reflected by the reflector 8 toward a light transmission region 11, so as to improve the luminance.

As shown in FIG. 4, the light transmission region 11 is arranged between a surface of the light guide plate 2 adjacent to the quantum dot plate 7 and the reflector 8.

According to the embodiments of the present disclosure, the light from the monochromatic light source of the backlight module are diffracted by the optical grating and then directed in a direction perpendicular to the light guide plate. Then, the monochromatic light from the monochromatic light source are converted by the quantum dot plate into white light. As a result, it is able to direct the light with different wavelengths in a direction perpendicular to the light guide plate, thereby to prevent the occurrence of the chromatic aberration due to different viewing angles of the viewer.

In addition, as compared with the backlight module in the related art with a prism plate, the backlight module in the embodiments of the present disclosure may be used to converge the light in a better manner, so no additional prism plate is provided. Further, theoretically, the light from the backlight module in the embodiments of the present disclosure may be distributed in a very narrow range of angles from −15° to +15° , so it is able to apply the backlight module to an LCD with a narrow viewing field even without any additional privacy film from 3M Company.

The present disclosure further provides in some embodiments a display device including the above-mentioned backlight module.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A backlight module, comprising:
a light guide plate;
a monochromatic light source arranged at a light-entering side of the light guide plate;
an optical grating arranged at a side of a light-exiting surface of the light guide plate, wherein monochromatic light from the monochromatic light source is diffracted by the optical gating and directed in a direction perpendicular to the light guide plate; and
a quantum dot plate arranged at the side of the light-exiting surface of the light guide plate and configured to convert the diffracted monochromatic light into white light.

2. The backlight module according to claim 1, wherein the monochromatic light source is a blue light source, and light from the blue light source has a wavelength not greater than 460 nm.

3. The backlight module according to claim 2, wherein the grating has a period of 300 nm to 390 nm.

4. The backlight module according to claim 1, wherein the light guide plate is a polymethyl methacrylate (PMMA) or Acryl light guide plate.

5. The backlight module according to claim 1, further comprising a reflector arranged at a side of the light guide plate away from the quantum dot plate.

6. The backlight module according to claim 1, wherein the monochromatic light source is arranged at a side of the light guide plate away from the quantum dot plate.

7. The backlight module according to claim 1, wherein the optical grating is arranged between the light guide plate and the quantum dot plate.

8. The backlight module according to claim 5, wherein the monochromatic light source is arranged between the reflector and the light guide plate.

9. The backlight module according to claim 5, wherein the monochromatic light source is arranged at a region formed by an extension of a light transmission region between a surface of the light guide plate adjacent to the quantum dot plate and the reflector in a direction parallel to the light guide plate.

10. A display device, comprising the backlight module according to claim 1.
